(19) United States
(12) Patent Application Publication
(10) Pub. No.: US 2015/0081930 A1
(43) Pub. Date: Mar. 19, 2015

(54) TABLET COMPUTER

(71) Applicant: UC-LOGIC TECHNOLOGY CORP., New Taipei City (TW)

(72) Inventor: Joe YU, New Taipei City (TW)

(21) Appl. No.: 14/472,408

(22) Filed: Aug. 29, 2014

(30) Foreign Application Priority Data
Sep. 13, 2013 (TW) 102133215
Sep. 13, 2013 (TW) 102217280

(51) Int. Cl. G06F 9/44; G06F 13/38

(52) U.S. Cl. CPC G06F 9/4411; G06F 13/385
USPC 710/14

(57) ABSTRACT

A tablet computer includes a video transmission port for input and output of a video signal, a data transmission port for input and output of a data signal, and a switching unit. The switching unit is operable by a user to cause the tablet computer to operate as a combination of a peripheral user input unit and a peripheral display device for an external electronic device. That is, a video signal generated by the external electronic device may be transmitted to the tablet computer through the video transmission port, and a data signal inputted using the tablet computer may be transmitted to the external electronic device through the data transmission port.

### CROSS-REFERENCE TO RELATED APPLICATION

This application claims priority to Taiwanese Application Nos. 102133215 and 102217280, both filed on Sep. 13, 2013.

### BACKGROUND OF THE INVENTION

1. Field of the Invention

The invention relates to a portable electronic device, and more particularly to a tablet computer that may operate as a peripheral device.

2. Description of the Related Art

Referring to FIG. 1, a conventional tablet computer 1 is shown to include a built-in display device 11, a display control circuit 12 that controls operation of the display device 11, and an HDMI (high-definition multimedia interface) port 13 for connecting to an external display device 2 (or an electronic device having a display device). The display control circuit 12 includes an HDMI output port 121 coupled to the HDMI port 13. When the HDMI port 13 is not connected to the external display device 2, the display control circuit 12 outputs to the display device 11 a video signal provided by a central processing unit 10 for display on the display device 11. On the other hand, when the HDMI port 13 is connected to the external display device 2, the display control circuit 12 outputs to the external display device 2 the video signal via the HDMI port 13 for display on the external display device 2. In addition, the tablet computer 1 may access a USB (universal serial bus) storage unit 15 and employ a USB input unit 16 (e.g., a transparent touch panel stacked on a screen of the display device 11) that are built in the tablet computer 1 via a USB control circuit 14 (e.g., a USB host or a USB device that conforms to USB on-the-go specification). The USB control circuit 14 may further access an external USB peripheral device 3 (e.g., a USB storage unit) via a USB port 17.

However, in conventional designs, an electronic device such as a desktop computer or a notebook computer may not employ the display device 11 of the tablet computer 1 to display video provided thereby, and may not use the USB input unit 16 to serve as an additional input interface, thereby limiting applications of the tablet computer 1, which may adversely affect consumer interest.

### SUMMARY OF THE INVENTION

Therefore, an object of the present invention is to provide a tablet computer that may be switched to operate as a computer device or a peripheral device.

According to the present invention, a tablet computer comprises:

a display device;

a video transmission port through which a video signal is to be inputted into or outputted from the tablet computer;

a display control circuit electrically connected to the display device, and including a video input port and a video output port;

an input unit for input operation by a user;

a data transmission port through which a data signal is to be inputted into or outputted from the tablet computer; and

a switching unit including a physical switch for user operation to switch between a first state and a second state, and a switching module electrically connected to the physical switch, the video transmission port, the display control circuit, the data transmission port and the input unit.

When the physical switch is in the first state, the switching module is configured to communicatively connect the video output port of the display control circuit to the video transmission port for enabling the display control circuit to output a video signal from the tablet computer via the video transmission port.

When the physical switch is in the second state, the switching module is configured to communicatively connect the video input port of the display control circuit to the video transmission port for enabling input of a video signal that is provided from the video transmission port into the display control circuit, the display control circuit configures the display device to display an image according to the video signal thus inputted, and the switching module is further configured to communicatively connect the input unit to the data transmission port, for enabling output from the tablet computer an input signal corresponding to input operation on the input unit by the user through the data transmission port.

### BRIEF DESCRIPTION OF THE DRAWINGS

Other features and advantages of the present invention will become apparent in the following detailed description of an embodiment with reference to the accompanying drawings, of which:

FIG. 1 is a block diagram illustrating a conventional tablet computer;

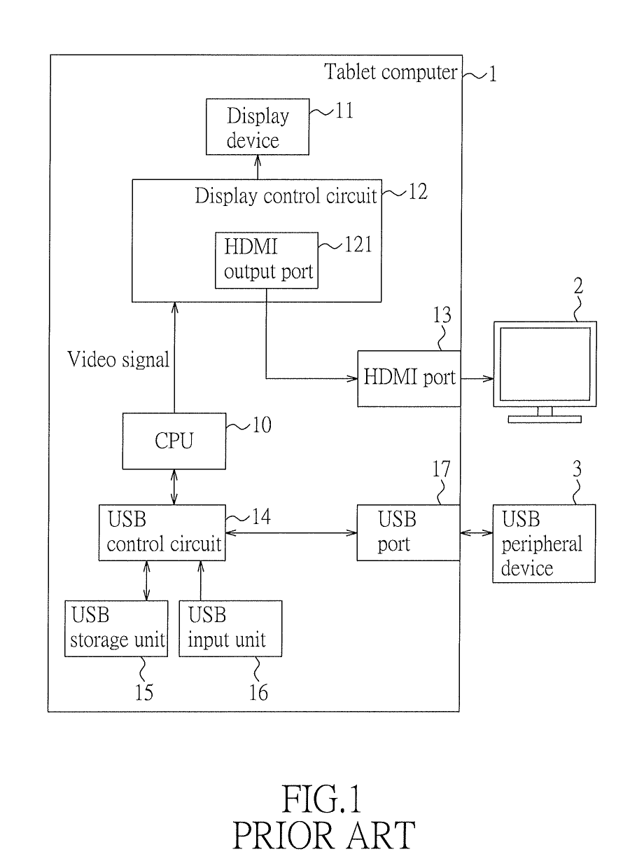

FIG. 2 is a block diagram illustrating an embodiment of a tablet computer according to the present invention, operating in a computer mode; and

FIG. 3 is a block diagram illustrating the embodiment of the tablet computer according to the present invention, operating in a peripheral mode.

### DETAILED DESCRIPTION OF THE EMBODIMENT

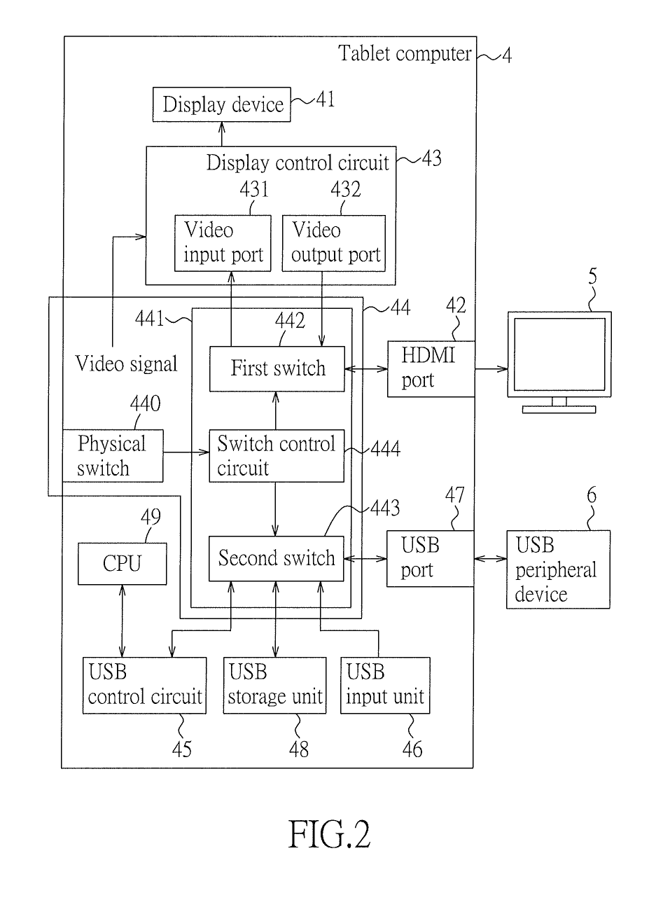

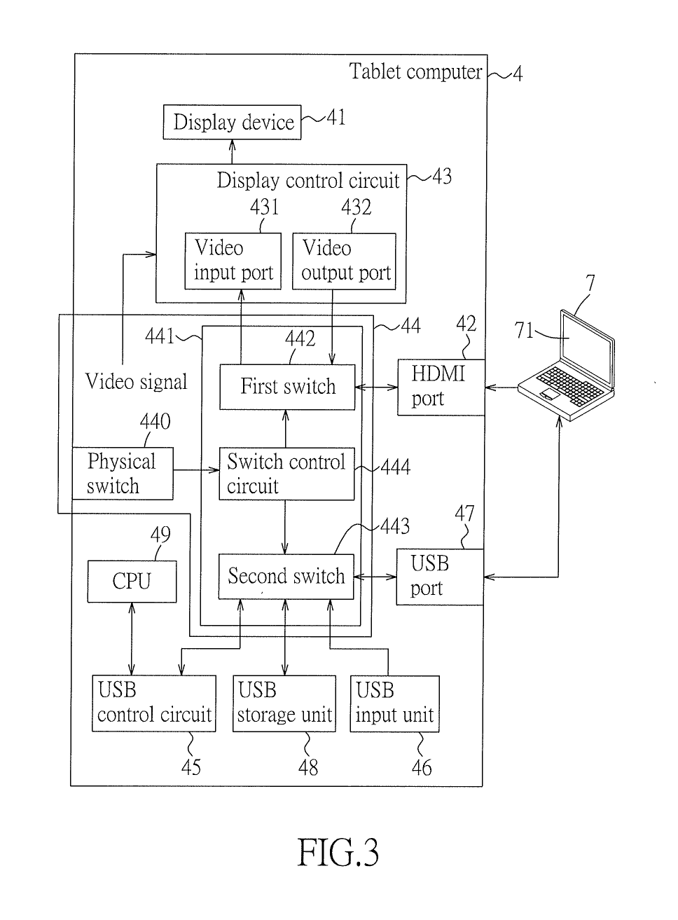

Referring to FIGS. 2 and 3, the embodiment of the tablet computer 4 according to this invention is shown to include a built-in display device 41, a video transmission port 42, a display control circuit 43, a switching unit 44, an interface control circuit 45, an input unit 46, a data transmission port 47, a built-in storage unit 48, and a CPU (central processing unit) 49.

In this embodiment, the video transmission port 42 conforms to, but is not limited to, an HDMI (high-definition multimedia interface) specification, is configured to receive video and audio data, and is called an HDMI port 42 hereinafter.

In this embodiment, the interface control circuit 45, the input unit 46, the data transmission port 47 and the storage unit 48 conform to, but are not limited to, a USB (universal serial bus) standard, and are respectively called a USB control circuit 45, a USB input unit 46, a USB port 47 and a USB storage unit 48 hereinafter. The USB control circuit 45 may be a USB host device or a USB OTG (on-the-go) device, and is electrically connected to the USB input unit 46, the USB port 47 and the USB storage unit 48 via the switching unit 44. The USB input unit 46 may be a transparent touch panel stacked on a screen of the display device 41 for input operation by a user, and generates an input signal in response to the input operation. The USB control circuit 45 transmits the input signal received from the USB input unit 46 to the CPU 49 for subsequent processing, and accesses the USB storage unit 48 according to instructions from the CPU 49. In addition, the USB control circuit 45 may access a USB peripheral device 6, which is electrically connected to the USB port 47, via the switching unit 44 and the USB port 47.

In this embodiment, the display control circuit 43 is coupled to the display device 41 for controlling display operation of the display device 41, and includes a video input port 431 and a video output port 432. In this embodiment, the video input port 431 is configured to receive a video signal conforming to the HDMI specification and received from the HDMI port 42, and the video output port 432 is configured to output a video signal conforming to the HDMI specification. The display control circuit 43 may include an HDMI transceiver, or separate HDMI transmitter and receiver, and the present invention should not be limited in this respect.

In this embodiment, the switching unit 44 includes a physical switch 440 for user operation to switch between a first state and a second state, and a switching module 441 including a first switch 442, a second switch 443 and a switch control circuit 444.

The first switch 442 is electrically connected to the switch control circuit 444, the HDMI port 42 and the video input port 431 and the video output port 432 of the display control circuit 43, and is operable by the switch control circuit 444 to electrically connect the HDMI port 42 to one of the video input port 431 and the video output port 432.

The second switch 443 is electrically connected to the switch control circuit 444, the USB control circuit 45, the USB input unit 46, the USB port 47 and the USB storage unit 48, and is operable by the switch control circuit 444 to electrically connect the USB input unit 46 to one of the USB control circuit 45 and the USB port 47.

The physical switch 440 is electrically connected to the switch control circuit 444 for switching the tablet computer 4 to operate between a computer mode and a peripheral mode therethrough. When the physical switch 440 is in the first state, the tablet computer 4 operates in the computer mode. In the computer mode, the switch control circuit 444 controls the first switch 442 to communicatively connect the video output port 432 of the display control circuit 43 to the HDMI port 42 for enabling the display control circuit 43 to output a video signal provided by the CPU 49 from the tablet computer 4 via the HDMI port 42. The switch control circuit 444 further controls the second switch 443 to communicatively connect the USB control circuit 45 to the USB input unit 46 and the USB storage unit 48, and to disconnect the USB input unit 46 from the USB port 47.

Referring to FIG. 2, the tablet computer 4 is shown to operate in the computer mode. When an external display device 5 is electrically connected to the HDMI port 42 of the tablet computer 4, the display control circuit 43 outputs the video signal provided by the CPU 49 to the video output port 432, and the video signal thus outputted is transmitted to the external display device 5 through the first switch 442 and the HDMI port 42 for display by the external display device 5. At the same time, the USB control circuit 45 may access the USB storage unit 48, and receive the input signal from the USB input unit 46 through the second switch 443. When the external USB peripheral device 6, such as a USB storage unit, is connected to the USB port 47, the USB control circuit 45 may further access the USB storage unit 6 through the second switch 443 and the USB port 47.

When the physical switch 440 is in the second state, the tablet computer 4 operates in the peripheral mode. In the peripheral mode, the switch control circuit 444 controls the first switch 442 to communicatively connect the video input port 431 of the display control circuit 43 to the HDMI port 42 for enabling input of a video signal that is inputted through the HDMI port 42 into the display control circuit 43 via the video input port 431, and the display control circuit 43 configures the display device 41 to display an image according to the video signal thus inputted. The switch control circuit 444 further controls the second switch 443 to communicatively connect the USB input unit 46 to the USB port 47, for enabling output from the tablet computer 4 an input signal corresponding to input operation on the USB input unit 46 by the user through the USB port 47. Since the USB control circuit 45 and the CPU 49 may not be used in the peripheral mode, the USB control circuit 45 and the CPU 49 may be configured to enter a sleep mode at this time.

Referring to FIG. 3, the tablet computer 4 is shown to operate in the peripheral mode. When an external electronic device 7, such as a notebook computer or a desktop computer, is electrically connected to the HDMI port 42 and the USB port 47 of the tablet computer 4, the electronic device 7 may provide a video signal, which is provided for display on its own display device 71, to the display control circuit 43 of the tablet computer 4 via the HDMI port 42, the first switch 442 and the video input port 431 for display on the display device 41. At the same time, the electronic device 7 may access the USB storage unit 48 of the tablet computer 4 via the USB port 47 and the second switch 443, and the input signal generated in response to input operation by a user on the USB input unit 46 may be transmitted to the electronic device 7 via the second switch 443 and the USB port 47 for relevant processing. The electronic device 7 may generate an image signal that corresponds to the input signal and that is provided to the display control circuit 43 of the tablet computer 4 via the HDMI port 42, the first switch 442 and the video input port 431 for displaying on the display device 41 of the tablet computer 4 an image corresponding to the input operation. Furthermore, the electronic device 7 may execute instructions according to the input signal provided by the USB input unit 46.

For example, when the electronic device 7 renders the USB input unit 46 (i.e., the transparent touch panel) to operate in a handwriting input mode, handwritten inputs on the USB input unit 46 may be transmitted to the electronic device 7 via the second switch 443 and the USB port 47 for proceeding with handwriting recognition, and the electronic device 7 may generate a corresponding image signal provided to the display control circuit 43 via the HDMI port 42, the first switch 442 and the video input port 431 for display on the display device 41. When the electronic device 7 renders the USB input unit 46 (i.e., the transparent touch panel) to operate in a drawing mode, drawn inputs on the USB input unit 46 may be recognized by the electronic device 7, and the electronic device 7 may generate a corresponding image signal for display on the display device 41. Then, the user may store the inputs (under the handwriting input mode or under the drawing mode) in either one of the USB storage unit 48 of the tablet computer 4 and a storage unit (not shown) of the electronic device 7.

When the electronic device 7 renders the USB input unit 46 (i.e., the transparent touch panel) to operate in a touch control mode, the user may touch a specific touch control region of the USB input unit 46 or a region of the USB input unit 46 that corresponds to an icon displayed on the display device 41 to run a corresponding application program or to execute a corresponding instruction, or may use various touch gestures to proceed with operations (e.g., zoom-in, zoom-out, copy, etc.) on the image displayed on the display device 41.

In summary, the user may switch the embodiment of the tablet computer 4 to operate in the computer mode or the peripheral mode by switching the physical switch 440. When the tablet computer 4 operates in the computer mode, the HDMI port 42 serves as an output interface for the video signal, and the USB port 47 may be used for connection to an external USB peripheral device 6. When the tablet computer 4 operates in the peripheral mode, the HDMI port 42 serves as an input interface for the video signal, and the USB port 47 may be used as a connection interface between the external electronic device 7 and the USB storage unit 48 and the USB input unit 46 that are built in the tablet computer 4, such that the USB input unit 46 may serve as another input interface of the electronic device 7.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A tablet computer comprising:
a display device;
a video transmission port through which a video signal is to be inputted into or outputted from said tablet computer;
a display control circuit electrically connected to said display device, and including a video input port and a video output port;
an input unit for input operation by a user;
a data transmission port through which a data signal is to be inputted into or outputted from said tablet computer; and
a switching unit including a physical switch for user operation to switch between a first state and a second state, and a switching module electrically connected to said physical switch, said video transmission port, said display control circuit, said data transmission port and said input unit, wherein:
when said physical switch is in the first state, said switching module is configured to communicatively connect said video output port of said display control circuit to said video transmission port for enabling said display control circuit to output a video signal from said tablet computer via said video transmission port; and
when said physical switch is in the second state, said switching module is configured to communicatively connect said video input port of said display control circuit to said video transmission port for enabling input of a video signal that is provided from said video transmission port into said display control circuit, said display control circuit configures said display device to display an image according to the video signal thus inputted, and said switching module is further configured to communicatively connect said input unit to said data transmission port, for enabling output from said tablet computer an input signal corresponding to input operation on said input unit by the user through said data transmission port.

2. The tablet computer according to claim 1, further comprising an interface control circuit electrically connected to said switching module, wherein, when said physical switch is in the first state, said switching module is further configured to communicatively connect said input unit to said interface control circuit.

3. The tablet computer according to claim 2, wherein each of said interface control circuit, said input unit and said data transmission port conforms to a universal serial bus (USB) standard.

4. The tablet computer according to claim 3, wherein each of said video transmission port, said video input port of said display control circuit and said video output port of said display control circuit conforms to a high-definition multimedia interface (HDMI) specification.

5. The tablet computer according to claim 3, wherein said interface control circuit is one of a USB host device and a USB OTG (on-the-go) device.

6. The tablet computer according to claim 3, wherein said input unit is a transparent touch panel stacked on a screen of said display device.

7. The tablet computer according to claim 3, further comprising a storage unit conforming to the USB standard and coupled to said switching module, wherein, when said physical switch is in the first state, said switching module is configured to communicatively connect said storage unit to said interface control circuit, and when said physical switch is in the second state, said switching module is configured to communicatively connect said storage unit to said data transmission port.

8. The tablet computer according to claim 1, wherein said input unit is a transparent touch panel stacked on a screen of said display device.
